(19) United States
(12) Patent Application Publication
(10) Pub. No.: US 2012/0174426 A1
(43) Pub. Date: Jul. 12, 2012

(54) LINT FREE CONTAINER

(76) Inventor: GEVORK KAMALMAZYAN, Los Angeles, CA (US)

(21) Appl. No.: 13/004,715

(22) Filed: Jan. 11, 2011

(51) Int. Cl. F26B 21/06

(52) U.S. Cl. 34/82

(57) ABSTRACT

The Lint Free Container is a commercial laundromat lint trap to prevent excessive amount of commercial laundromat dryer lint to sit on rooftop, cause fire, damaging roof, etc. The Lint Free Container is a rectangular shaped box with screen cover on top for airflow. It also has trays inside filled with water to capture the lint. On the front it has additional airflow by using louvered dryer vents. On top of the screen it has a sprinkler system to wash the screen and fill the trays with water.

### BRIEF SUMMARY

The Lint Free Container is used to prevent lint from sitting on commercial Laundromat roofs. It is collected in a box rather then floating in the air. It prevents the lint to clog the gutters, catch on fire, and damage buildings.

### BRIEF DESCRIPTION OF DRAWING

FIG. 1 pg. 3—Rectangular box where commercial dryer dock is inserted in.

FIG. 2 pg. 3—Top view where screen is placed for airflow to prevent dryer malfunction.

FIG. 3 pg, 3—Sprinkler system with timer to wash screen cover for airflow.

FIG. 4 pg. 3—Inside tray filled with water to capture lint.

FIG. 5 pg. 4—Prototype

FIG. 6 pg. 5—Excessive lint produced by dryer before Lint Free Box. Fire Hazard and property damage.

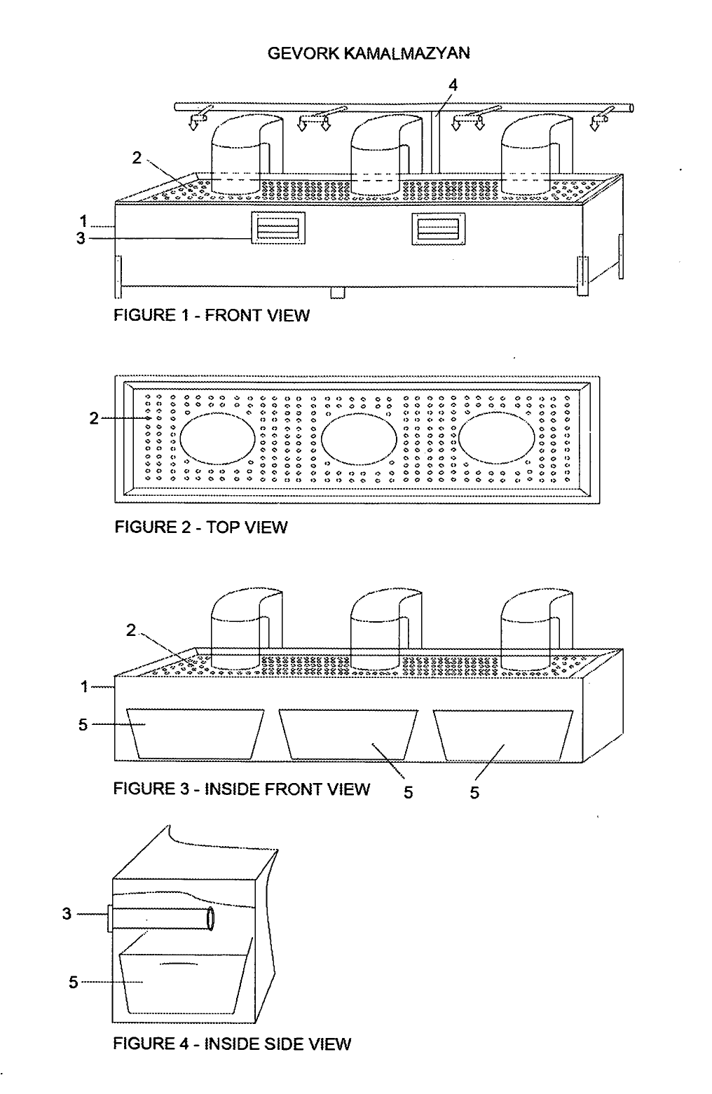

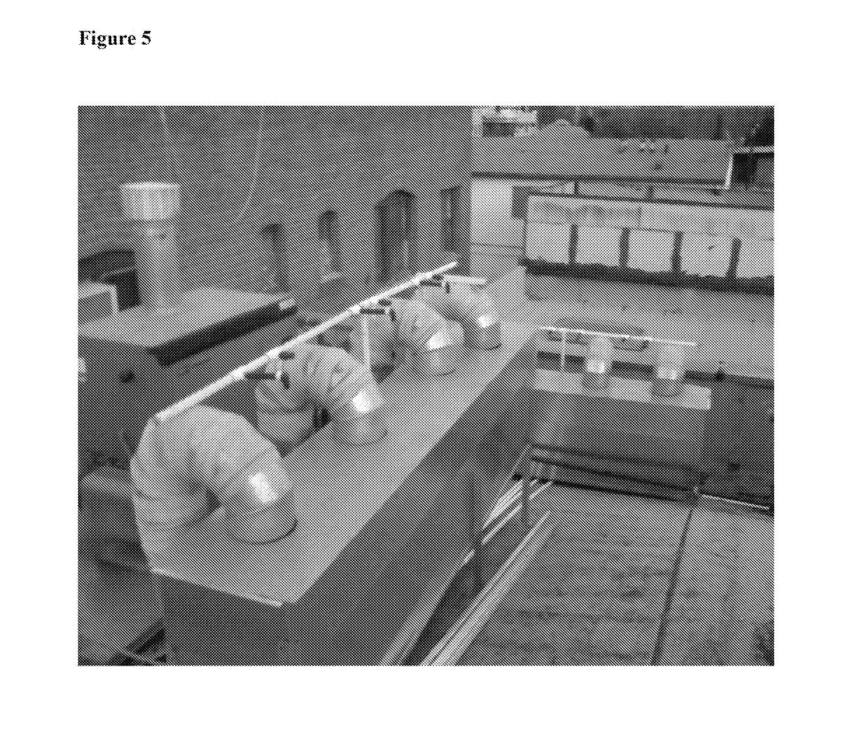

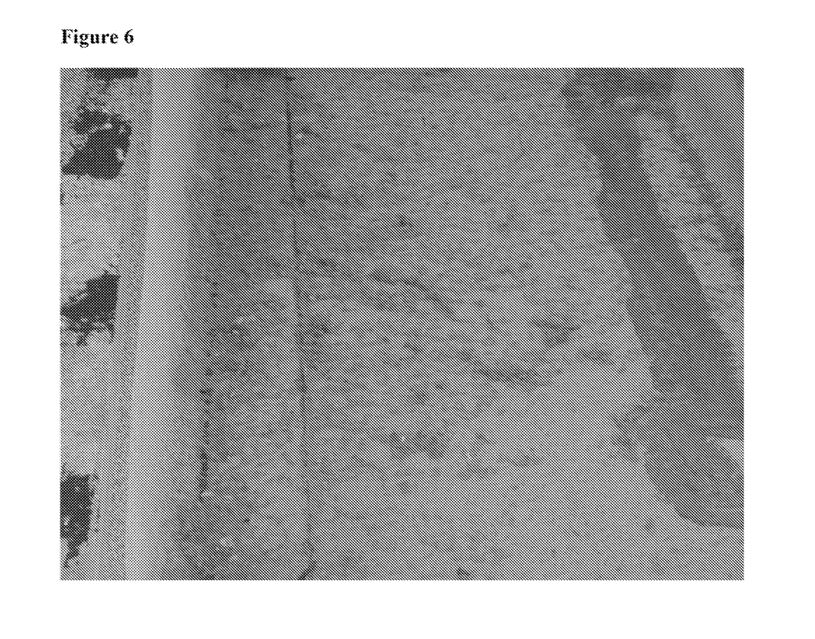

### DETAILED DESCRIPTION OF THE INVENTION

1.Lint Free Box is a rectangular shaped box made of Galvanized steel. Size is custom made.

2.Screen cover is made of Galvanized steel and placed on top of the Lint Free Box.

3.Sprinkler system is setup by using PVC pipes to connect to water valve and a timer.

4.The inside tray filled with water is used to capture lint that is blown out of the dryer.

1. A lint box assembly made in any shape or size that is connected to dryer duct to prevent lint to float in air. A Lint Free Container assembly comprising: a box in any shape or size according to dryer duct, a screen cover put on Lint Free Container for ventilation to dryer, a tray filled with water put in Lint Free Container to capture lint. Type of watering/sprinkler system to wash screen cover that is clogged by lint to allow airflow and fill water in tray.

2. The Lint Free Container as clamed in claim 1, wherein Lint Free Container prevents excessive amount of lint produced by dryer to flow in open air.

3. The Lint Free Container as clamed in claim 1, wherein the screen cover placed on top of Lint Free Container allows air flow to the dryers.

4. The Lint Free Container as clamed in claim 1, wherein water/sprinkler system is used to wash screen cover that has been clogged by lint and refill water in tray.

5. The Lint Free Container as clamed in claim 1, wherein could be in any shape, size and design depending on the layout and amount of dryer air duct.

6. The Lint Free Container is to prevent extra lint produced by the dryer to sit on roof and or property damages and or cause fire.
